(19) United States
(12) Patent Application Publication
(10) Pub. No.: US 2014/0306910 A1
(43) Pub. Date: Oct. 16, 2014

(54) ID TRACKING OF GESTURE TOUCH GEOMETRY

(71) Applicant: QUALCOMM Incorporated, San Diego, CA (US)

(72) Inventors: William Yee-Ming Huang, Vista, CA (US); Suhail Jalil, Poway, CA (US); Raghukul Tilak, San Diego, CA (US); Mohamed Imtiaz Ahmed, San Marcos, CA (US)

(73) Assignee: QUALCOMM Incorporated, San Diego, CA (US)

(21) Appl. No.: 14/251,418

(22) Filed: Apr. 11, 2014

Related U.S. Application Data
(60) Provisional application No. 61/812,195, filed on Apr. 15, 2013.

(51) Int. Cl. G06F 3/041

(52) U.S. Cl. CPC G06F 3/041
USPC 345/173

(57) ABSTRACT

Systems, apparatus and methods for touch detection are presented. Multiple fingers (two to five) from one hand are tracked based on fast moving fingers being group in a fixed position relative to one another. Touch points are matched from a first time to a second time wherein the matching minimizes relative movement between the tracked fingers. In some embodiments, a touch sensor receives first and second touch data comprising touch detections. A processor matches, for several candidate matches, touch detections from a first set to a second set. For each match, the processor further computes a rotation and translation matrix between the first set and the second set; applies the rotation and translation matrix to the first set to determine a result; and calculate a Euclidian distance between the result and the second set. Finally, the processor selects a match, from the several matches, having a minimum Euclidian distance.

### CROSS-REFERENCE TO RELATED APPLICATIONS

This application claims the benefit of and priority under 35 U.S.C. §119(e) to U.S. Provisional Application No. 61/812,195, filed Apr. 15, 2013, titled “ID TRACKING OF GESTURE TOUCH GEOMETRY” and which is incorporated herein by reference.

### BACKGROUND

The present disclosure relates generally to a touch device, and more particularly, to methods and apparatuses for detecting multi-touch swipes on the touch device.

Devices such as computing devices, mobile devices, kiosks, etc. often employ a touch screen interface with which a user can interact with the devices by touch input (e.g., touch by a user or an input tool such as a pen). Touch screen devices employing the touch screen interface provide convenience to users, as the users can directly interact with the touch screen. The touch screen devices receive the touch input, and execute various operations based on the touch input. For example, a user may touch an icon displayed on the touch screen to execute a software application associated with the icon, or a user may draw on the touch screen to create drawings. The user may also drag and drop items on the touch screen or may pan a view on the touch screen with two fingers. Thus, a touch screen device that is capable of accurately analyzing the touch input on the touch screen is needed to accurately execute desired operations. Multiple touches occurring at the same time on the device may be more difficult to accurately determine how the multiple touches should connect to other multiple touches in a later or following time frame, and thus accurate methods for detecting multiple touches across multiple time frames are desired.

### BRIEF SUMMARY

Disclosed are systems, apparatus and methods for tracking touch detections.

According to some aspects, disclosed is a method for touch detection, the method comprising: receiving first touch data comprising a first plurality of touch detections recorded at a first time; receiving second touch data comprising a second plurality of touch detections recorded at a second time; matching, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and matching, for each match, further comprises: computing a rotation and translation matrix between the first set and the second set; applying the rotation and translation matrix to the first set to determine a result; and calculating a Euclidian distance between the result and the second set; and selecting a match, from the several matches, having a minimum Euclidian distance.

According to some aspects, disclosed is a device for touch detection, the device comprising: a touch sensor configured to: receive first touch data comprising a first plurality of touch detections recorded at a first time; and receive second touch data comprising a second plurality of touch detections recorded at a second time; and a processor coupled to the touch sensor and configured to: match, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the processor, for each match, is further configured to: compute a rotation and translation matrix between the first set and the second set; apply the rotation and translation matrix to the first set to determine a result; and calculate a Euclidian distance between the result and the second set; and select a match, from the several matches, having a minimum Euclidian distance.

According to some aspects, disclosed is a device for touch detection, the device comprising: means for receiving first touch data comprising a first plurality of touch detections recorded at a first time; means for receiving second touch data comprising a second plurality of touch detections recorded at a second time; means for matching, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the means for matching, for each match, further comprises: means for computing a rotation and translation matrix between the first set and the second set; means for applying the rotation and translation matrix to the first set to determine a result; and means for calculating a Euclidian distance between the result and the second set; and means for selecting a match, from the several matches, having a minimum Euclidian distance.

According to some aspects, disclosed is a non-transient computer-readable storage medium including program code stored thereon, comprising program code to: receive first touch data comprising a first plurality of touch detections recorded at a first time; receive second touch data comprising a second plurality of touch detections recorded at a second time; match, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the program code to match, for each match, further comprises program code to: compute a rotation and translation matrix between the first set and the second set; apply the rotation and translation matrix to the first set to determine a result; and calculate a Euclidian distance between the result and the second set; and select a match, from the several matches, having a minimum Euclidian distance.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a diagram illustrating an example of mobile device architecture with a touch screen display and an external display device according to some embodiments.

FIG. 2 is a diagram illustrating an example of a mobile touch screen device with a touch screen controller according to some embodiments.

FIG. 3 illustrates an example of a capacitive touch processing data path in a touch screen device according to some embodiments.

FIG. 4 illustrates a closer look at display and touch subsystems in mobile-handset architecture according to some embodiments.

FIGS. 5A, 5B, and 5C illustrate an exemplary touch screen input across two sequential times t and t+1, with a corresponding incorrect solution and a corresponding correct solution detecting connections between the two times.

FIGS. 6A-6G illustrate an example iterative algorithm for determining a correct solution to detect connections between two sequential times t and t+1, according to some embodiments.

FIG. 7 illustrates an example flowchart according to some embodiments.

FIGS. 8 and 9 illustrate methods for touch detection according to some embodiments.

FIG. 10 illustrates a device for touch detection according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of touch screen devices will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above are also included within the scope of computer-readable media.

As used herein, a device or mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile device” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

Touch screen technology enables various types of uses. As discussed above, a user may touch a touch screen to execute various operations such as execution of an application. In one example, the touch screen provides a user interface with a direct touch such as a virtual-keyboard and user-directed controls. The user interface with the touch screen may provide proximity detection. The user may handwrite on the touch screen. In another example, the touch screen technology may be used for security features, such as surveillance, intrusion detection and authentication, and may be used for a use-environment control such as a lighting control and an appliance control. In another example, the touch screen technology may be used for healthcare applications (e.g., a remote sensing environment, prognosis and diagnosis).

Several types of touch screen technology are available today, with different designs, resolutions, sizes, etc. Examples of the touch screen technology with lower resolution include acoustic pulse recognition (APR), dispersive signal technology (DST), surface acoustic wave (SAW), traditional infrared (infrared or near infrared), waveguide infrared, optical, and force sensing. A typical mobile device includes a capacitive touch screen (e.g., a mutual projective-capacitance touch screen), which allows for higher resolution and a thin size of the screen. Further, a capacitive touch screen provides good accuracy, good linearity and good response time, as well as relatively low chances of false negatives and false positives. Therefore, the capacitive touch screen is widely used in mobile devices such as mobile phones and tablets. Examples of a capacitive touch screen used in mobile devices include an in-cell touch screen and an on-cell touch screen, which are discussed infra.

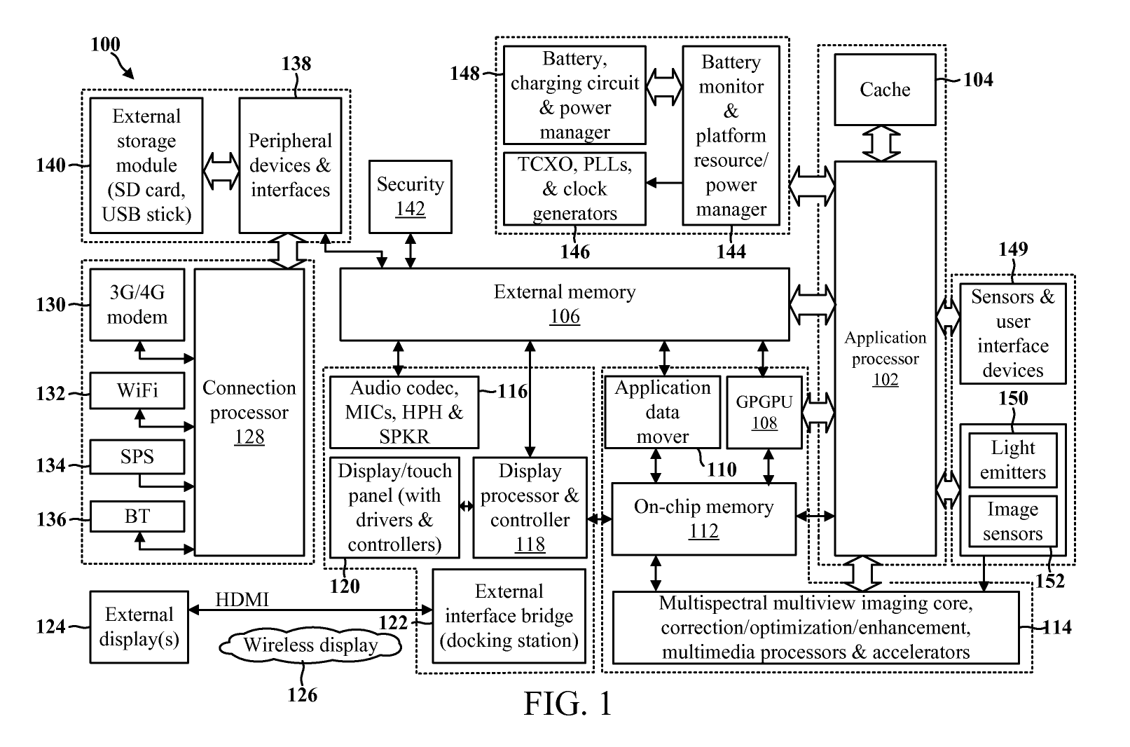

FIG. 1 is a diagram illustrating an example of mobile device architecture 100 with a display/touch panel 120 and may connect to an external display 124 according to some embodiments. In this example, the mobile device architecture 100 includes an application processor 102, a cache 104, an external memory 106, a general-purpose graphics processing unit (GPGPU) 108, an application data mover 110, an on-chip memory 112 that is coupled to the application data mover 110 and the GPGPU 108, and a multispectral multiview imaging core, correction/optimization/enhancement, multimedia processors and accelerators component 114 that is coupled to the on-chip memory 112. The application processor 102 communicates with the cache 104, the external memory 106, the GPGPU 108, the on-chip memory 112, and the multispectral multiview imaging core, correction/optimization/enhancement, multimedia processors and accelerators component 114. The mobile device architecture 100 further includes an audio codec, microphones, headphone/earphone, and speaker component 116, a display processor and controller component 118, and a display/touch panel (with drivers and controllers) component 120 coupled to the display processor and controller component 118. The mobile device architecture 100 may optionally include an external interface bridge (e.g., a docking station) 122 coupled to the display processor and controller component 118, and an external display 124 coupled to the external interface bridge 122. The external display 124 may be coupled to the external interface bridge 122 via a wireless display connection 126 or a wired connection, such as a high definition multimedia interface (HDMI) connection. The mobile device architecture 100 further includes a connection processor 128 coupled to a 3G/4G modem 130, a WiFi modem 132, a Satellite Positioning System (SPS) sensor 134, and a Bluetooth module 136. The mobile device architecture 100 also includes peripheral devices and interfaces 138 that communicate with an external storage module 140, the connection processor 128, and the external memory 106. The mobile device architecture 100 also includes a security component 142. The external memory 106 is coupled to the GPGPU 108, the application data mover 110, the display processor and controller component 118, the audio codec, microphones, headphone/earphone and speaker component 116, the connection processor 128, the peripheral devices and interfaces 138, and the security component 142.

In some embodiments, the mobile device architecture 100 further includes a battery monitor and platform resource/power manager component 144 that is coupled to a battery charging circuit and power manager component 148 and to temperature compensated crystal oscillators (TCXOs), phase lock loops (PLLs), and clock generators component 146. The battery monitor and platform resource/power manager component 144 is also coupled to the application processor 102. The mobile device architecture 100 further includes sensors and user interface devices component 149 coupled to the application processor 102, and includes light emitters 150 and image sensors 152 coupled to the application processor 102. The image sensors 152 are also coupled to the multispectral multiview imaging core, correction/optimization/enhancement, multimedia processors and accelerators component 114.

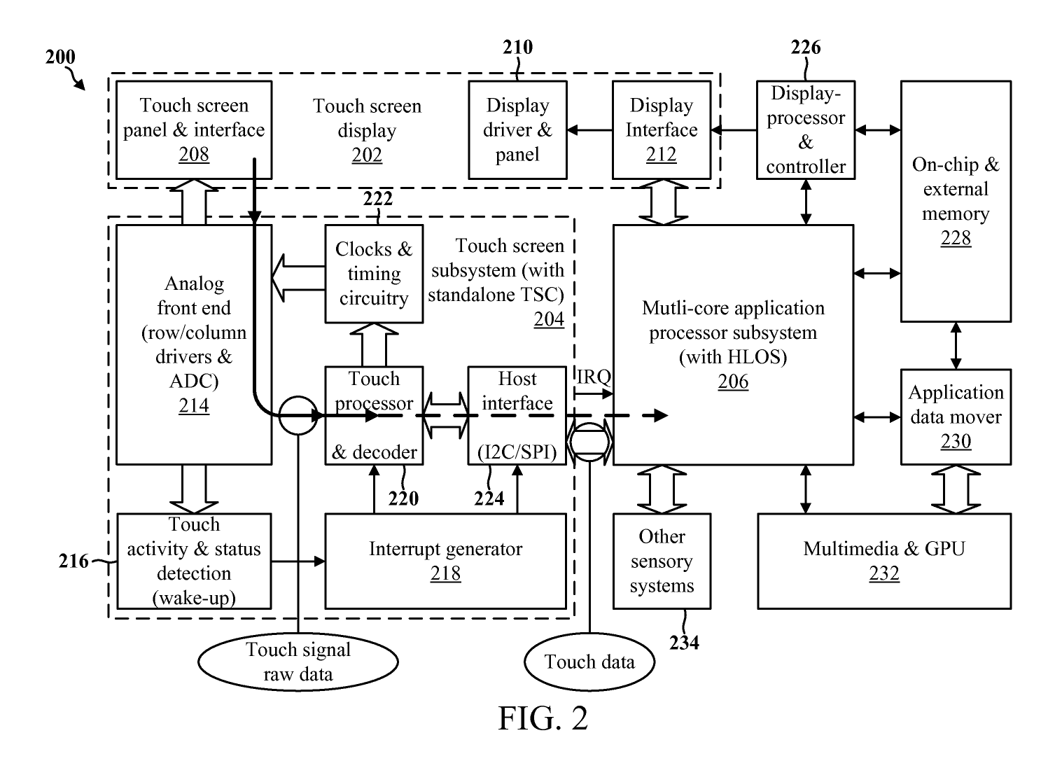

FIG. 2 is a diagram illustrating an example of a mobile touch screen device 200 with a touch screen controller according to some embodiments. The mobile touch screen device 200 includes a touch screen display unit 202 and a touch screen subsystem with a standalone touch screen controller 204 that are coupled to a multi-core application processor subsystem with High Level Output Specification (with HLOS) 206. The touch screen display unit 202 includes a touch screen panel and interface unit 208, a display driver and panel unit 210, and a display interface 212. The display interface 212 is coupled to the display driver and panel unit 210 and the multi-core application processor subsystem (with HLOS) 206. The touch screen panel and interface unit 208 receives a touch input via a user touch, and the display driver and panel unit 210 displays an image. The touch screen controller 204 includes an analog front end 214, a touch activity and status detection unit 216, an interrupt generator 218, a touch processor and decoder unit 220, clocks and timing circuitry 222, and a host interface 224. The analog front end 214 communicates with the touch screen panel and interface unit 208 to receive an analog touch signal based on a user touch on the touch screen, and may convert the analog touch signal to a digital touch signal to create touch signal raw data. The analog front end 214 may include row/column drivers and an analog-to-digital converter (ADC).

The touch activity and status detection unit 216 receives the touch signal from the analog front end 214 and then communicates to the interrupt generator 218 of the presence of the user touch, such that the interrupt generator 218 communicates a trigger signal to the touch processor and decoder unit 220. When the touch processor and decoder unit 220 receives the trigger signal from the interrupt generator 218, the touch processor and decoder unit 220 receives the touch signal raw data from the analog front end 214 and processes the touch signal raw data to create touch data. The touch processor and decoder unit 220 sends the touch data to the host interface 224, and then the host interface 224 forwards the touch data to the multi-core application processor subsystem 206. The touch processor and decoder unit 220 is also coupled to the clocks and timing circuitry 222 that communicates with the analog front end 214.

In some embodiments, processing of the touch signal raw data is processed in the multi-core application processor subsystem 206 instead of in the decoder unit 220. In some such embodiments, the touch screen controller 204 or one or more components thereof, for example, the decoder unit 220, may be omitted. In other such embodiments, the touch screen controller 204 and/or all components thereof are included, but touch signal raw data is passed through to the multi-core application processor subsystem 206 without or with reduced processing. In some embodiments, processing of the touch signal raw data is distributed between the decoder unit 220 and the multi-core application processor subsystem 206.

The mobile touch screen device 200 also includes a display processor and controller unit 226 that sends information to the display interface 212, and is coupled to the multi-core application processor subsystem 206. The mobile touch screen device 200 further includes an on-chip and external memory 228, an application data mover 230, a multimedia and graphics processing unit (GPU) 232, and other sensor systems 234, which are coupled to the multi-core application processor subsystem 206. The on-chip and external memory 228 is coupled to the display processor and controller unit 226 and the application data mover 230. The application data mover 230 is also coupled to the multimedia and graphics processing unit 232.

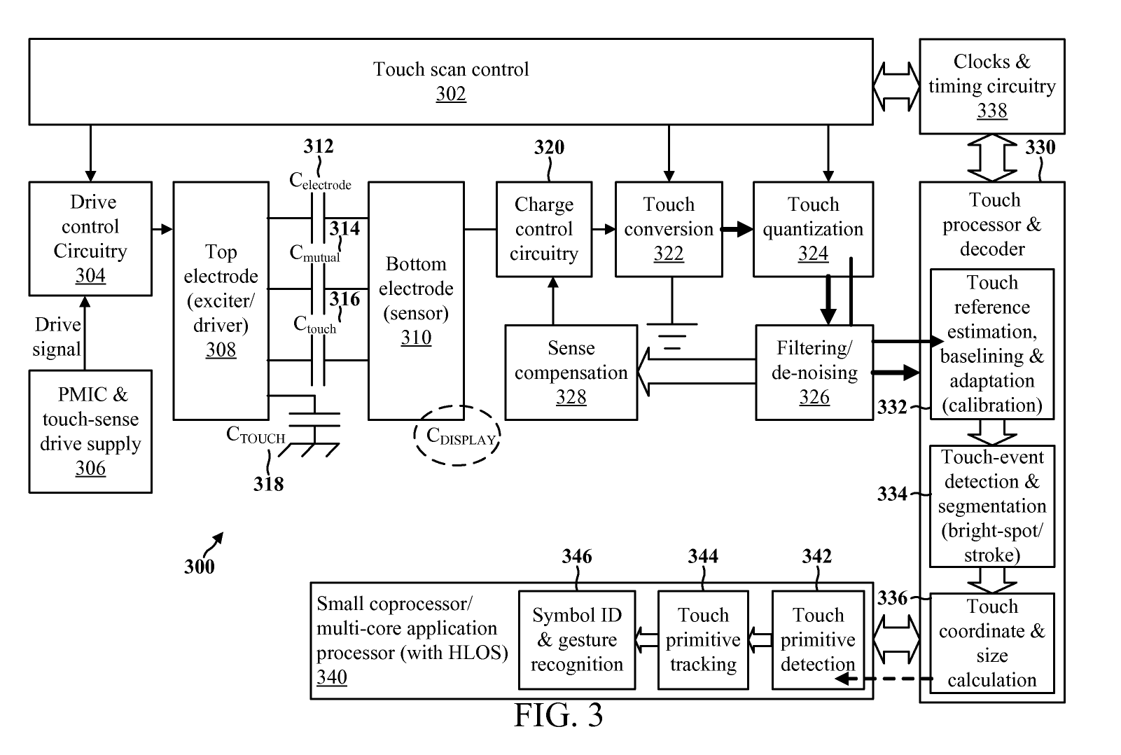

FIG. 3 illustrates an example of a capacitive touch processing data path in a touch screen device 300 according to some embodiments. The touch screen device 300 has a touch scan control unit 302 that is coupled to drive control circuitry 304, which receives a drive signal from a power management integrated circuit (PMIC) and touch-sense drive supply unit 306. The drive control circuitry 304 is coupled to a top electrode 308. The capacitive touch screen includes two sets of electrodes, where the first set includes the top electrode 308 (or an exciter/driver electrode) and the second set includes a bottom electrode 310 (or a sensor electrode). The top electrode 308 is coupled to the bottom electrode 310 with capacitance between the top electrode 308 and the bottom electrode 310. The capacitance between the top electrode 308 and the bottom electrode 310 includes an electrode capacitance (C_{electrode} 312), a mutual capacitance (Cₘᵤₜᵤₐₗ 314), and a touch capacitance (C_{touch} 316). A user touch capacitance (C_{TOUCH} 318) may form when there is a user touch on the top electrode 308 of the touch screen. With the user touch on the top electrode 308, the user touch capacitance 318 induces capacitance on the top electrode 308, thus creating a new discharge path for the top electrode 308 through the user touch. For example, before a user's finger touches the top electrode 308, the electrical charge available on the top electrode 308 is routed to the bottom electrode 310. A user touch on a touch screen creates a discharge path through the user touch, thus changing a discharge rate of the charge at the touch screen by introducing the user touch capacitance 318. The user touch capacitance (C_{TOUCH} 318) created by a user touch may be far greater than capacitances between the top electrode 308 and the bottom electrode 310 (e.g., the electrode capacitance (C_{electrode} 312), the mutual capacitance (Cₘᵤₜᵤₐₗ 314), and the touch capacitance (C_{touch} 316)), and thus may preempt the other capacitances (e.g., C_{electrode} 312, Cₘᵤₜᵤₐₗ 314, and C_{touch} 316) between the top electrode 308 and the bottom electrode 310. Also shown is a display capacitance (C_{DISPLAY}), which is the effective capacitive load contribution by the display assembly.

The bottom electrode 310 is coupled to charge control circuitry 320. The charge control circuitry 320 controls a touch signal received from the top and bottom electrodes 308 and 310, and sends the controlled signal to a touch conversion unit 322, which converts the controlled signal to a proper signal for quantization. The touch conversion unit 322 sends the converted signal to the touch quantization unit 324 for quantization of the converted signal. The touch conversion unit 322 and the touch quantization unit 324 are also coupled to the touch scan control unit 302. The touch quantization unit 324 sends the quantized signal to a filtering/de-noising unit 326. After filtering/de-noising of the quantized signal at the filtering/de-noising unit 326, the filtering/de-noising unit 326 sends the resulting signal to a sense compensation unit 328 and a touch processor and decoder unit 330. The sense compensation unit 328 uses the signal from the filtering/de-noising unit 326 to perform sense compensation and provide a sense compensation signal to the charge control circuitry 320. In other words, the sense compensation unit 328 is used to adjust the sensitivity of the touch sensing at the top and bottom electrodes 308 and 310 via the charge control circuitry 320.

In some embodiments, the touch processor and decoder unit 330 communicates with clocks and timing circuitry 338, which communicates with the touch scan control unit 302. The touch processor and decoder unit 330 includes a touch reference estimation, a baselining, and adaptation unit 332 that receives the resulting signal from the filtering/de-noising unit 326, a touch-event detection and segmentation unit 334, and a touch coordinate and size calculation unit 336. The touch reference estimation, baselining, and adaptation unit 332 is coupled to the touch-event detection and segmentation unit 334, which is coupled to the touch coordinate and size calculation unit 336. The touch processor and decoder unit 330 also communicates with a small coprocessor/multi-core application processor (with HLOS) 340, which includes a touch primitive detection unit 342, a touch primitive tracking unit 344, and a symbol ID and gesture recognition unit 346. The touch primitive detection unit 342 receives a signal from the touch coordinate and size calculation unit 336 to perform touch primitive detection, and then the touch primitive tracking unit 344 coupled to the touch primitive detection unit 342 performs the touch primitive tracking The symbol ID and gesture recognition unit 346 coupled to the touch primitive tracking unit 344 performs recognition of a symbol ID and/or gesture.

Various touch sensing techniques are used in the touch screen technology. Touch capacitance sensing techniques may include electric field sensing, charge transfer, force sensing resistor, relaxation oscillator, capacitance-to-digital conversion (CDC), a dual ramp, sigma-delta modulation, and successive approximation with single-slope ADC. The touch capacitance sensing techniques used in today's projected-capacitance (P-CAP) touch screen controller may include a frequency based touch-capacitance measurement, a time based touch-capacitance measurement, and/or a voltage based touch-capacitance measurement.

In the frequency based measurement, a touch capacitor is used to create an RC oscillator, and then a time constant, a frequency, and/or a period are measured according to some embodiments. The frequency based measurement includes a first method using a relaxation oscillator, a second method using frequency modulation and a third method a synchronous demodulator. The first method using the relaxation oscillator uses a sensor capacitor as a timing element in an oscillator. In the second method using the frequency modulation, a capacitive sensing module uses a constant current source/sink to control an oscillator frequency. The third method using the synchronous demodulator measures a capacitor's AC impedance by exciting the capacitance with a sine wave source and measuring a capacitor's current and voltage with a synchronous demodulator four-wire ratiometric coupled to the capacitor.

The time based measurement measures charge/discharge time dependent on touch capacitance. The time based measurement includes methods using resistor capacitor charge timing, charge transfer, and capacitor charge timing using a successive approximation register (SAR). The method using resistor capacitor charge timing measures sensor capacitor charge/discharge time for with a constant voltage. In the method using charge transfer, charging the sensor capacitor and integrating the charge over several cycles, ADC or comparison to a reference voltage, determines charge time. Many charge transfer techniques resemble sigma-delta ADC. In the method using capacitor charge timing using the SAR, varying the current through the sensor capacitor, matches a reference ramp.

The voltage based measurement monitors a magnitude of a voltage to sense user touch. The voltage based measurement includes methods using a charge time measuring unit, a charge voltage measuring unit, and a capacitance voltage divide. The method using the charge time measuring unit charges a touch capacitor with a constant current source, and measures the time to reach a voltage threshold. The method using the charge voltage measuring unit charges the capacitor from a constant current source for a known time and measures the voltage across the capacitor. The method using the charge voltage measuring unit requires a very low current, a high precision current source, and a high impedance input to measure the voltage. The method using the capacitance voltage divide uses a charge amplifier that converts the ratio of the sensor capacitor to a reference capacitor into a voltage (Capacitive-Voltage-Divide). The method using the capacitance voltage divide is the most common method for interfacing to precision low capacitance sensors.

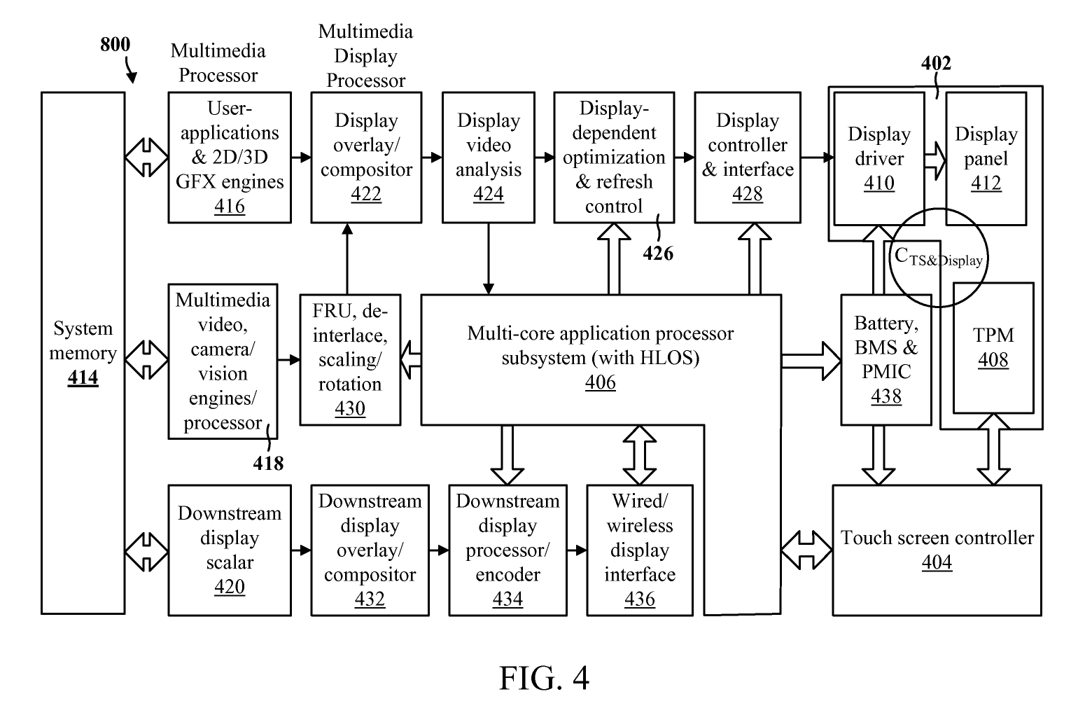

FIG. 4 illustrates a closer look at display and touch subsystems in mobile handset architecture according to some embodiments. The mobile handset 400 includes a touch screen display unit 402, a touch screen controller 404, and a multi-core application processor subsystem (with HLOS) 406. The touch screen display unit 402 includes a touch panel module (TPM) unit 408 coupled to the touch screen controller 404, a display driver 410, and a display panel 412 that is coupled to the display driver 410. Also shown is the touch sensor and display capacitance (C_{TS&Display}), which is the effective capacitive load for the display module overlaid with the touch sensor. The mobile handset 400 also includes a system memory 414, and further includes a user applications and 2D/3D graphics/graphical effects (GFX) engines unit 416, a multimedia video, camera/vision engines/processor unit 418, and a downstream display scalar 420 that are coupled to the system memory 414. The user applications and 2D/3D GFX engines unit 416 communicates with a display overlay/compositor 422, which communicates with a display video analysis unit 424. The display video analysis unit 424 communicates with a display dependent optimization and refresh control unit 426, which communicates with a display controller and interface unit 428. The display controller and interface unit 428 communicates with the display driver 410. The multimedia video, camera/vision engines/processor unit 418 communicates with a frame rate upconverter (FRU), de-interlace, scaling/rotation component 430, which communicates with the display overlay/compositor 422. The downstream display scalar 420 communicates with a downstream display overlay/compositor 432, which communicates with a downstream display processor/encoder unit 434. The downstream display processor/encoder unit 434 communicates with a wired/wireless display interface 436. The multi-core application processor subsystem (with HLOS) 406 communicates with the display video analysis unit 424, the display-dependent optimization and refresh control unit 426, the display controller and interface unit 428, the FRU, de-interlace, scaling/rotation component 430, the downstream display overlay/compositor 432, the downstream display processor/encoder unit 434, and the wired/wireless display interface 436. The mobile handset 400 also includes a battery, battery management system (BMS) and PMIC unit 438 coupled to the display driver 410, the touch screen controller 404, and the multi-core application processor subsystem (with HLOS) 406.

In some embodiments, processing of the touch signal raw data can be processed by the multi-core application processor subsystem (with HLOS) 406 instead of in the touch screen controller 404. In some such embodiments, the touch screen controller 404 or one or more components thereof may be omitted. In other such embodiments, the touch screen controller 404 and/or all components thereof are included, but touch signal raw data is passed through to the multi-core application processor subsystem (with HLOS) 406 without or with reduced processing.

There are known challenges for accurate sensing of touch in the touch screen. For example, a touch capacitance can be small, depending on a touch medium. The touch capacitance is sensed over high output impedance. Further, a touch transducer often operates in platforms with a large parasitic or in a noisy environment. In addition, touch transducer operation can be skewed with offsets and its dynamic range may be limited by a DC bias.

Several factors may affect touch screen signal quality. On the touch screen panel, the signal quality may be affected by a touch-sense type, resolution, a touch sensor size, fill factor, touch panel module integration configuration (e.g., out-cell, on-cell, in-cell, etc.), and a scan overhead. A type of a touch medium such as a hand/finger or stylus and a size of touch as well as responsivity such as touch sense efficiency and a transconductance gain may affect the signal quality. Further, sensitivity, linearity, dynamic range, and a saturation level may affect the signal quality. In addition, noises such as no-touch signal noise (e.g., thermal and substrate noise), a fixed-pattern noise (e.g., touch panel spatial non-uniformity), and a temporal noise (e.g., EMI/RFI, supply noise, display noise, use noise, use-environment noise) may affect the signal quality. In some instances, temporal noise can include noise imposed on the ground plane, for example, by a poorly designed charger.

Often gesture input geometry includes multiple touch inputs. For example, a user may use a multi-finger swipe, such as a three-finger swipe, to signify a particular action. User input is tracked from during sequential times, such that one point at a first time (e.g., time t) is tracked to one point at a second time (e.g., t+1). Any spurious points (i.e., points not matched to a tracked finger input) may be discarded. Detecting and tracking multiple touch inputs on a touch screen at one point in time to another point in time, however, may complicate touch detection algorithms.

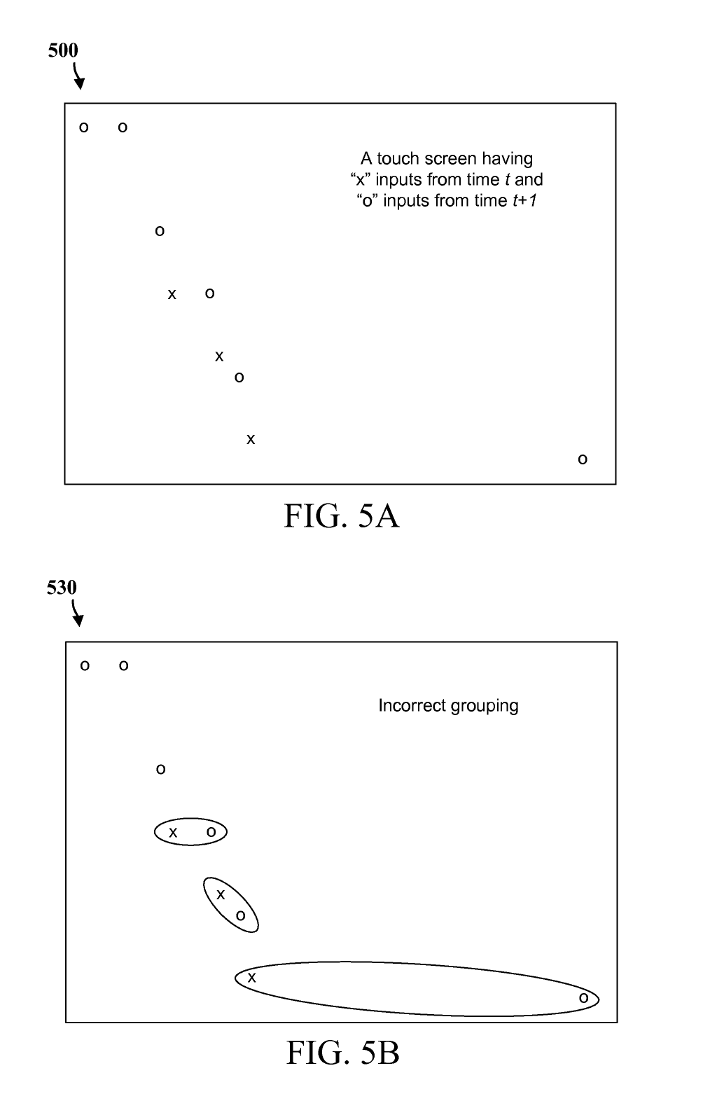

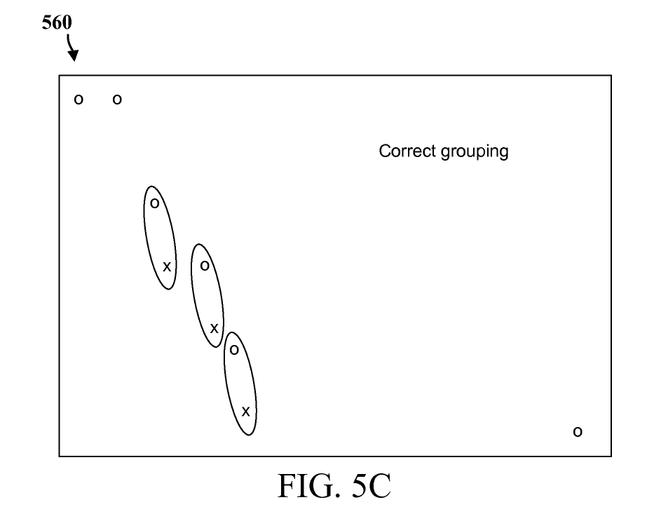

FIGS. 5A, 5B, and 5C illustrate an exemplary touch screen input across two sequential times t and t+1, with a corresponding incorrect solution and a corresponding correct solution detecting connections between the two times.

For example, referring to FIG. 5A, a user may have made three swiping motions simultaneously, one with each of three fingertips, from time t to time t+1. Here, example touch screen 500 shows three touch inputs, labeled with an “x”, made at time t. For example, the three touch inputs may represent three fingertips touching the touch screen 500 all at time t. At time t+1, the touch screen 500 may detect multiple touches, each represented by an “o”. One can see, however, that while there are three “x” detections, there are actually six “o” detections. Assuming the three fingertips made a swiping motion from time t to time t+1, then three of the “o” detections are spurious detections made, for example, by noise or other errors. Touch detection algorithms may be used to accurately track the movements of multiple touches at once (e.g., the three fingertips from time t to time t+1).

Referring to FIG. 5B, various multi-touch algorithms in the art may generate the wrong result. In touch screen solution 530, for example, using one such algorithm known in the art, such as the Euclidean bipartite algorithm, which finds a solution based on minimizing the sum of the distances between possible connections made from time t to time t+1, the wrong result is generated, as shown in the three circles of FIG. 5B. Here, known detection techniques in the art may erroneously generate a solution using spurious touches, like the “o” touch data point in the bottom-right corner of touch screen solution 530.

Referring to FIG. 5C, the correct connections between time t and time t+1 are shown in the circles in touch screen 560. As shown, the user may have placed three of his fingertips at time t at the locations marked with an “x”. At time t+1, the user may then have moved his fingertips across the touch screen 560 over to the locations within the circles, respectively, marked with an “o”. Clearly, the solution shown in FIG. 5B generated the wrong result. It is desirable, therefore, to implement a multi-touch detection algorithm that may more accurately and reliably detect motion swipes.

Generally, a touch detection algorithm may limit finger input (e.g., multi-finger fast swipes) to one or two degrees of freedom to represent a corresponding one or two hand swiping input. A fast swipe may be a movement greater than a predetermined threshold or speed. Multiple fingers may be grouped together, such as two, three, four or five fingers. For this discussion, a thumb is considered a finger. For example, a user may use multiple fingers in a one-hand input for a multi-finger input gesture.

Typically, relative finger positions for a gesture remain constant. For example, when used as an input gesture, a middle finger may move “randomly” about a touch screen but will stay between inputs provided by an index finger and a ring finger. That is, fingers stay positioned relative to one another in a constant fashion. Typically, fingers from a single hand do not move independently of one another. For example, a right hand showing movement of an index finger to the right, a middle finger up, and a ring finger to the left is highly unlikely or impossible. A touch detection algorithm may consider only possible or likely trajectories from points that define typical finger movement such that fingers are constrained or fixed relative to one another.

When finger tips are used for input gestures, movement may be characterized by a translation and/or a rotation. Translation may be represented by a change in center of mass of finger tips and may be defined with a 2D matrix. Rotation may be represented by an angular change about this center of mass. Rotation may also be defined with another 2D matrix. A touch detection algorithm may similarly constrain trajectories using a Markov model to “tie fingers” together such that the fingers move in a group.

Trajectories derived from input points may be limited to a fixed displacement with little or no rotation. Alternatively, trajectories from input points may be limited to both a fixed displacement with rotation. Alternatively, trajectories from input points may be limited to a rotation with little or no displacement. A threshold may be used to determine whether a trajectory represents sufficient translation verses little or no translation. A different threshold may be used to determine whether a trajectory represents sufficient rotation verses little or no rotation.

One degree of freedom is represented by a combination of translation and rotation. When swiping, fingers staying in a fixed position relative to each other with a determined linear displacement and/or a determined angular rotation. A second set of fingers from a second hand may represent a second degree of freedom. When a gesture is limited to one hand, a touch detection algorithm may similarly limit trajectories to a single degree of freedom. When a touch detection algorithm accepts gestures from two hands, the touch detection algorithm may limit points providing trajectories showing two degrees of freedom. The touch detection algorithm may further constrain trajectories to points not allowing (unlikely) twisted hand motion. For example, a touch detection algorithm may constrain trajectories representing rotations to less than 360 degrees of rotation in one hand. Similarly, a touch detection algorithm may restrict trajectories from two hands that would otherwise require hands to pass through one another.

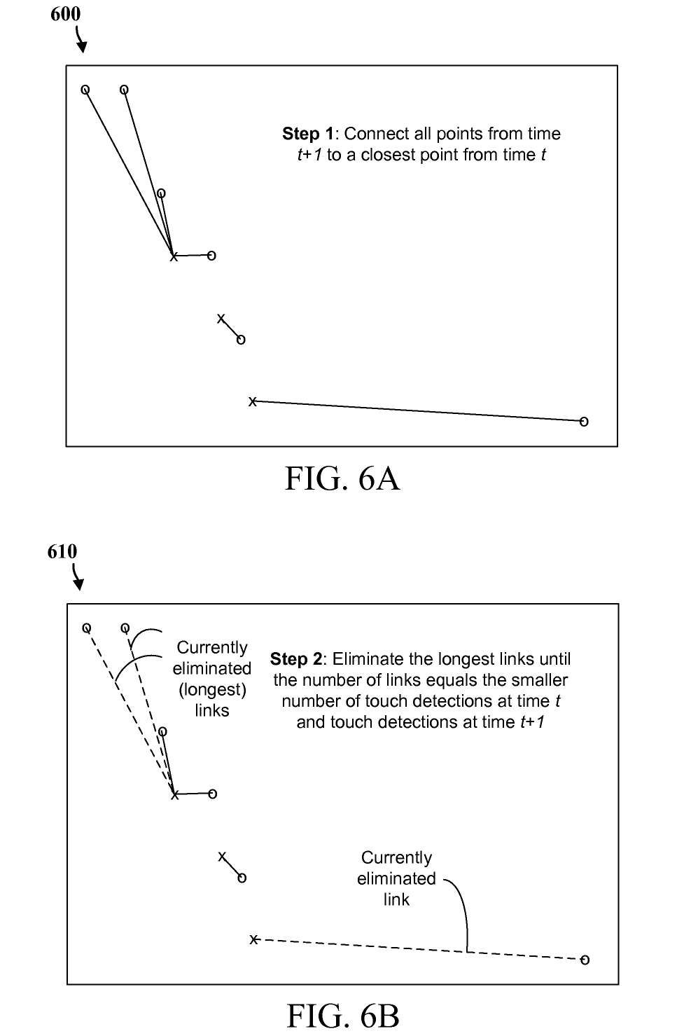

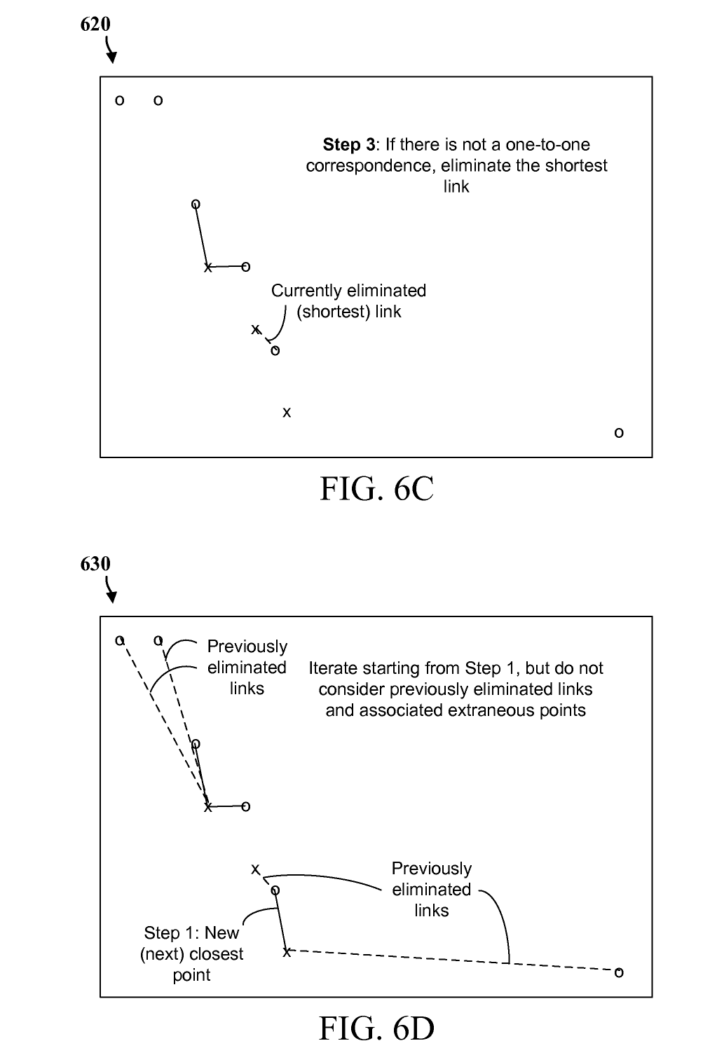

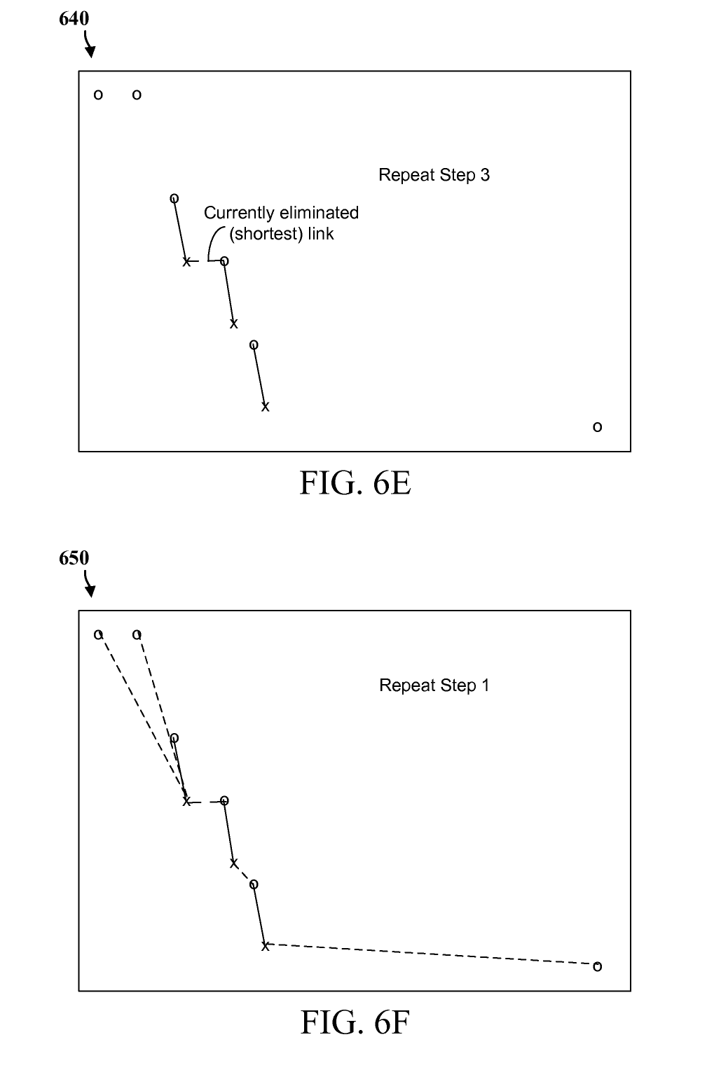

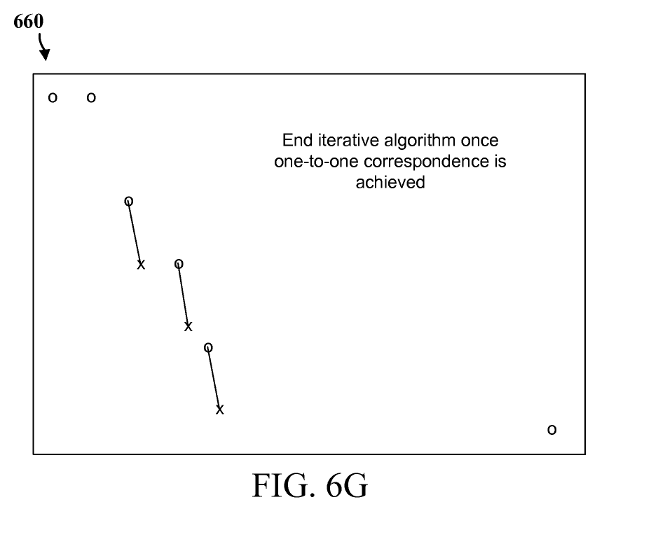

FIGS. 6A-6G illustrate an example iterative algorithm for determining a correct solution to detect connections between two sequential times t and t+1, according to some embodiments.

Referring to FIG. 6A, in some embodiments, a computer-implemented algorithm may correlate the touches from time t with the correct corresponding touches at time t+1 with an iterative three-step process, an shown in the follow example. First, at illustration 600, in some embodiments, the first step is to connect all points from time t+1 to a closest point from time t. In this case, the solid lines show all the connections formed in this first step. Here, there are more points detected at time t+1 than at time t. In other cases, there may be more points at time t than at time t+1, in which case there will be more “x” points connected to fewer “o” points.

Referring to FIG. 6B, at illustration 610, a second step is implemented as follows. The longest links or connections formed in the first step at FIG. 6A are eliminated, until the total number of links equals the smaller number of touch detections among time t and time t+1. For example, here, there are fewer “x” points (e.g., three points) than “o” points (e.g., six points), and thus the total number of links should equal the total number of “x” points (e.g., three points), corresponding to the total number of detections at time t. Thus, here, the longest links, corresponding to the connections to the spurious detections in the farthest corners of illustration 610, are eliminated, as shown.

Referring to FIG. 6C, at illustration 620, the third step is to determine whether there is a one-to-one correspondence between detections at time t to detections at time t+1. In this case, the one-to-one correspondence check does not hold to be true. As shown, the upper-left most “x” point has two connections to two “o” points, and thus there is not a one-to-one correspondence. At this third step, if the one-to-one correspondence is found to be true, then the algorithm ends. However, if it is not true, then the shortest link is eliminated, and the algorithm iterates back to step 1. Thus, here, the shortest link is eliminated, as shown by the dotted line between the single “x” point and single “o” point in FIG. 6C. While eliminating the shortest link may seem counterintuitive, a reasonable justification for doing so is because most likely, the shortest link is not a possible swipe due to the size of a user's fingers in relation to the touch screen. In other words, the width of a user's fingers may be too wide for the shortest link to even be possible with a swipe.

Referring to FIG. 6D, at illustration 630, since a one-to-one correspondence was not established, the algorithm iterates back to step 1, except with the added constraint that none of the previously eliminated edges or points are considered. For example, in this case, the edges connecting to the longest link to the “o” points removed in step 2 are not considered, since they were already eliminated. Additionally, the previously eliminated shortest link removed in step 3 is also not considered. Thus, employing the process of step 1, which connects all of the “o” points to the closest “x” points, the result is shown in FIG. 6D according to the solid lines.

Referring to FIG. 6E, at illustration 640, the process continues on to repeat step 3. It may be noted that step 2 may also be repeated, but since the number of connections or links is already equal to the smaller number of touch detections (e.g., three detections), step 2 is moot and does not bare repeating. Thus, illustration 640 shows step 3 being repeated. Here, the one-to-one correspondence is checked again, and like before, it is found not to be true. Thus, the shortest link is again eliminated, as shown by the dotted line connecting the upper-left most “x” point to the “o” point to its right. Again, the iterative algorithm repeats, going back to step 1.

Referring to FIG. 6F, the algorithm continues according to illustration 650. Step 1 is repeated again, with the previously eliminated edges and points again not considered. Thus, the solid lines represent the connections made at this step, with the dotted lines and points representing the previously eliminated edges and points not allowed to be considered.

Referring to FIG. 6G, the iterative algorithm ends according to illustration 660, where at repeated step 3, a one-to-one correspondence is finally achieved. Thus, the final solution is shown in illustration 660, connecting the “x” points to the correctly corresponding “o” points.

The aforementioned example steps as described in FIGS. 6A-6G may apply to just two time frames (e.g., time t to time t+1). Supposing there were many touch detections made over a larger time span (e.g., {t, t+1, t+2, . . . t+n}) then each pair of times (e.g., {t+i, t+i+1} for all integers i) may be processed through the described algorithm, similar to the processes in FIGS. 6A-6G. The correct points according to the algorithm for each pair of times may then be connected together to form an interconnected path of touch detections that would correspond to the multi-touch swipes made by the user.

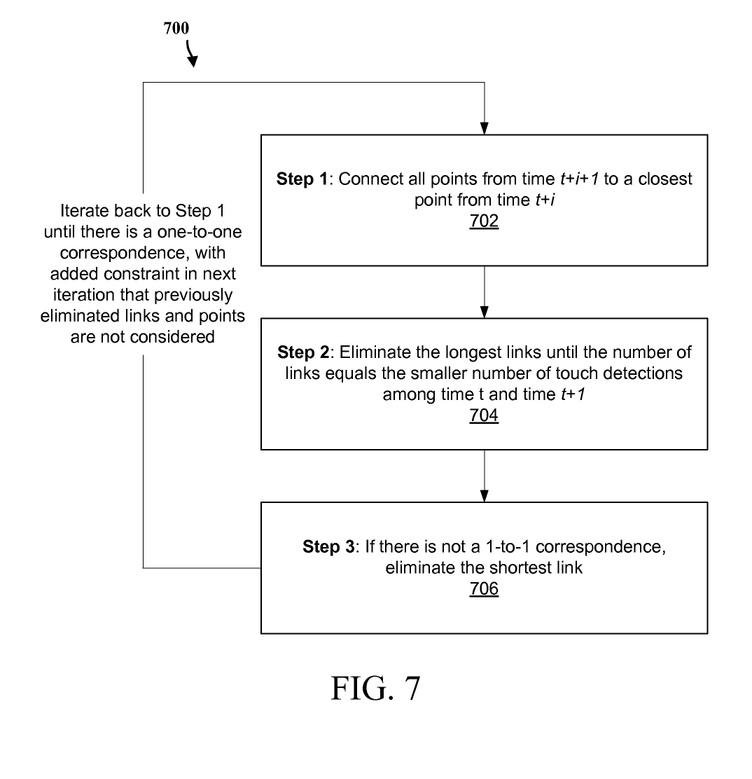

Referring FIG. 7, flowchart 700 illustrates an example process according to some embodiments. At step 702, in some embodiments, the iterative algorithm first connects all points from time t+i+1 to a closest point from time t+i, for any integer i. If there are more points detected at time t, then in some embodiments, all points from time t may be connected to a closest point from time t+i+1.

At step 704, the example process may eliminate the longest links connected between points from time t+i with time t+i+1 until the number of links equals the smaller number of touch detections among time t and time t+i+1. For example, if there are five touch detections at time t+i and only two touch detections at time t+i+1, then step 704 eliminates the longest links until there are only two links, corresponding to the smaller number of touch detections at time t+i+1.

At step 706, the example process may then determine if there is a one-to-one correspondence between connections from points at time t+i to point at time t+i+1. If there is not a one-to-one correspondence, then the shortest link is eliminated, and the example process iterates back to step 702 and repeats through steps 702, 704, and 706, but with the previously eliminated edges and points no longer considered.

The example process ends when it is determined that there is a one-to-one correspondence between connections from points at time t+i to point at time t+i+1.

In some embodiments, this example process is repeated for each time t+i and t+i+1, for all recorded frames i. For example, there may be 500 recorded touch frames, and thus each frame pairs (e.g., {0, 1}, {1, 2}, {2, 3} . . . {399, 500}) would need to be evaluated according to the described example process. The evaluated connections for each frame pair may then be connected to form a map or path of the user's swipes across the touch screen.

The previous description described one implementation that inherently groups fingers together during a swipe. The following description describes a general description that explicitly group fingers together.

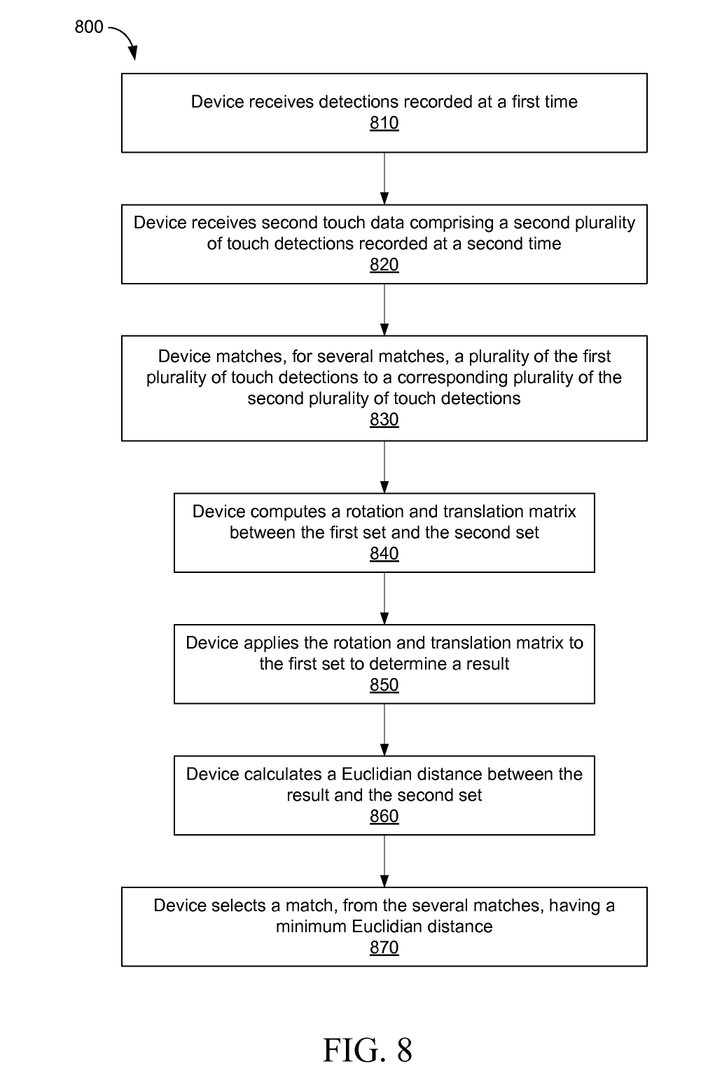

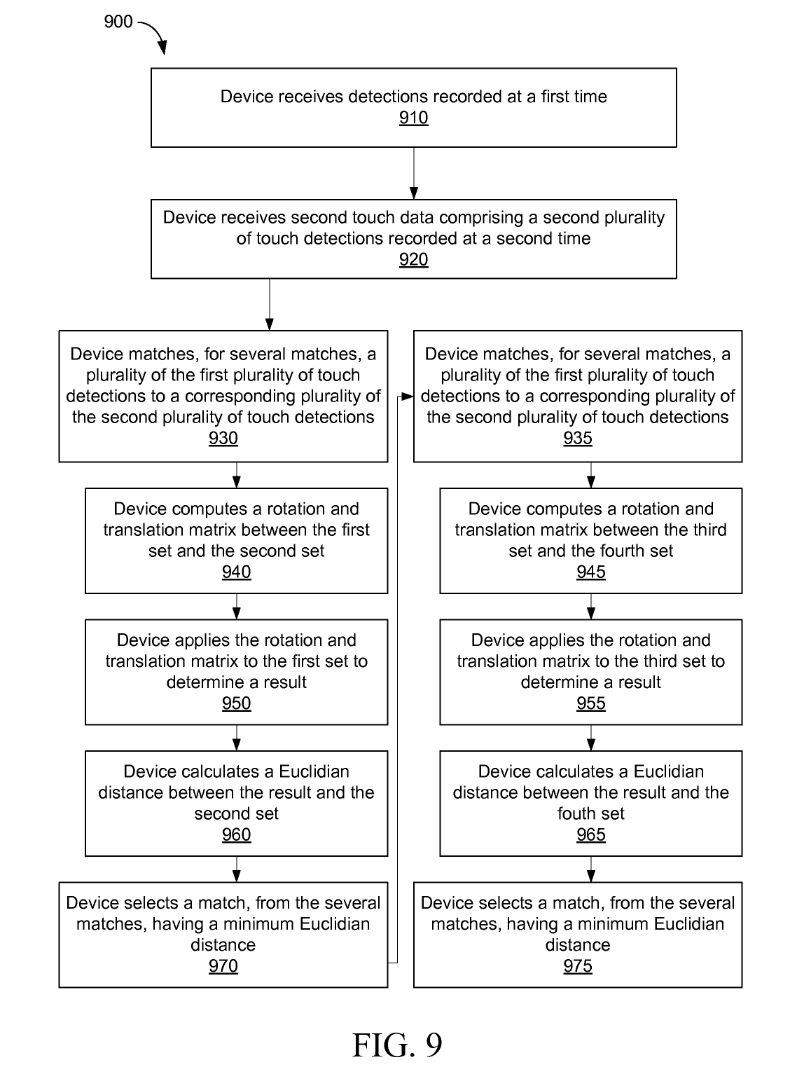

FIGS. 8 and 9 illustrate methods for touch detection according to some embodiments. In FIG. 8, a method 800 is illustrated for touch detection of at least one hand according to some embodiments. At 810, a device receives first touch data comprising a first plurality of touch detections recorded at a first time. At 820, the device receives second touch data comprising a second plurality of touch detections recorded at a second time. Movement of the first touch to the second touch may be above a threshold speed. For example, the movement method described below may be limited to fast or sweeping gestures.

A count of the first plurality of touch detections sometimes does not equal a count of the second plurality of touch detections. For example, a count of the first plurality of touch detections may be greater than a count of the second plurality of touch detections. In other situations, a count of the first plurality of touch detections may be less than a count of the second plurality of touch detections. Often a mismatch may occur by including extra detections of noise. Some embodiments operate on a fixed number of finger touch points (e.g., exactly two points, exactly three points or exactly four points) for gestures that use the specific number of finger points. For example, a three-point gesture may be sweeping of a thumb, an index finger and a middle finger from left to right and then from top to bottom.

At 830, the device matches a plurality of the first plurality of touch detections to a corresponding plurality of the second plurality of touch detections for each of several candidate matches. Either the plurality of the first plurality of touch detections comprises a first set and the corresponding plurality of the second plurality of touch detections comprises a second set, or alternatively, the plurality of the first plurality of touch detections comprises the second set and the corresponding plurality of the second plurality of touch detections comprises the first set. The matching may comprise an exhaustive matching and a selection may be made from the absolute minimum calculated Euclidian distance from all candidate matches. The Euclidian distance is the distance between two points that is given by the Pythagorean formula and one would measure with a ruler. Alternatively, as described below, a threshold distance or a RANSAC (RANdom SAmple Consensus) algorithm may be used to limit a total number of match operations performed.

For each matching, the method further comprises computing, applying and calculating as described below.

At 840, the device computes a rotation and translation matrix between the first set and the second set. The rotation and translation matrix may comprise a single matrix or may be represented as two matrices. Alternatively, the rotation and translation matrix may be represented with two vectors: a direction vector indicating a linear displacement (how much and in what direction) and an angular vector indicating an angular displacement between the first touch data and the second touch data. For example, linear displacement may be identified with a vector between the center of mass of the first touch data and the center of mass of the second touch data. The angular displacement between the first touch data and the second touch data may identify a rotation between the first touch data and the second touch data, assuming the centers of mass overlap, to minimize the Euclidian distance. In some embodiments, a device computing comprises a device determining a translation between a center of mass of the first set and a center of mass of the second set, and also determining an angular momentum between the first set and the second set.

At 850, the device applies the rotation and translation matrix to the first set to determine a result. Applying the rotation and translation matrix may comprise multiplying each point in the first set with the rotation and translation matrix to form the result. At 860, the device calculates a Euclidian distance between the result and the second set.

At 870, the device selects a match, from the several candidate matches, having a minimum Euclidian distance. Selecting the match may comprise selecting a first match having a Euclidian distance less than a threshold distance. That is, selecting the first match under of threshold distance such that exhaustive match is unnecessary. Alternatively, a RANSAC algorithm may be used to select candidate matches. A RANSAC algorithm may be applied as an iterative method to track finger positions from the plurality of touch detections which contains outliers. The method described above may be applied to two, three, four or five fingers on one hand. The method may be expanded to include multiple fingers from two hands.

In FIG. 9, a method 900 is illustrated for touch detection of at least one hand according to some embodiments. For a first hand, the process 910 to 970 is describes above in corresponding steps 810 to 870. Steps 935, 945, 955, 965 and 975 correspond to steps 930, 940, 950, 960 and 970, respectively.

At 935, the device matches the plurality of the first plurality of touch detections to a corresponding plurality of the second plurality of touch detections for each of several candidate matches for a second hand. The touch points used during step 930 may be removed before starting step 935. Either the plurality of the first plurality of touch detections comprises a third set and the corresponding plurality of the second plurality of touch detections comprises a fourth set, or alternatively, the plurality of the first plurality of touch detections comprises the fourth set and the corresponding plurality of the second plurality of touch detections comprises the third set.

At 945, the device computes a rotation and translation matrix between the third set and the fourth set. At 955, the device applies the rotation and translation matrix to the third set to determine a result. At 965, the device calculates a Euclidian distance between the result and the fourth set. At 975, the device selects a match, from the several candidate matches, having a minimum Euclidian distance.

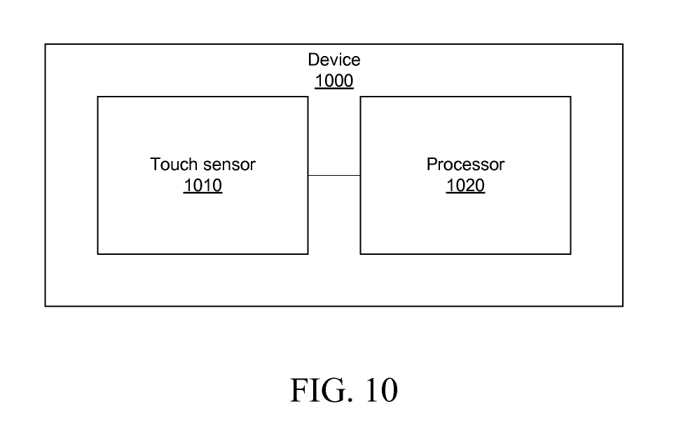

FIG. 10 illustrates a device 1000 for touch detection according to some embodiments. The device 1000 may be a mobile device and includes a touch sensor 1010 and a processor 1020. The touch sensor 1010 is configured to receive first touch data comprising a first plurality of touch detections recorded at a first time, and receive second touch data comprising a second plurality of touch detections recorded at a second time. Therefore, the touch sensor 1010 acts as means for receiving.

The processor 1020 is coupled to the touch sensor 1010 and is configured to match and select. Specifically, the processor 1020 is configured to match, for several matches, a plurality of the first plurality of touch detections to a corresponding plurality of the second plurality of touch detections.

The processor 1020, for each match, is further configured to: compute, apply and calculate. That is, the processor 1020 is configure to: compute a rotation and translation matrix between the first set and the second set; apply the rotation and translation matrix to the first set to determine a result; and calculate a Euclidian distance between the result and the second set. Furthermore, the processor 1020 is configured to select a match, from the several matches, having a minimum Euclidian distance. Likewise, the processor 1020 acts as means for matching, computing, applying, calculating and selecting.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Moreover, nothing disclosed herein is intended to be dedicated to the public.

What is claimed is:

1. A method for touch detection, the method comprising:
receiving first touch data comprising a first plurality of touch detections recorded at a first time;
receiving second touch data comprising a second plurality of touch detections recorded at a second time;
matching, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and matching, for each match, further comprises:
computing a rotation and translation matrix between the first set and the second set;
applying the rotation and translation matrix to the first set to determine a result; and
calculating a Euclidian distance between the result and the second set; and
selecting a match, from the several matches, having a minimum Euclidian distance.

2. The method of claim 1, wherein movement is above a threshold speed.

3. The method of claim 1, wherein a count of the first plurality of touch detections does not equal a count of the second plurality of touch detections.

4. The method of claim 1, wherein the plurality of the first plurality of touch detections comprises exactly two points.

5. The method of claim 1, wherein the plurality of the first plurality of touch detections comprises exactly three points.

6. The method of claim 1, wherein the plurality of the first plurality of touch detections comprises exactly four points.

7. The method of claim 1, wherein the rotation and translation matrix comprises a single matrix.

8. The method of claim 1, wherein applying the rotation and translation matrix comprises multiplying each point in the first set with the rotation and translation matrix to form the result.

9. The method of claim 1, wherein the plurality of the first plurality of touch detections comprises the first set and the corresponding plurality of the second plurality of touch detections comprise the second set.

10. The method of claim 1, wherein the plurality of the first plurality of touch detections comprises the second set and the corresponding plurality of the second plurality of touch detections comprise the first set.

11. The method of claim 1, wherein selecting the match comprises selecting a first match having a Euclidian distance less than a threshold distance.

12. The method of claim 1, wherein matching comprises an exhaustive matching.

13. The method of claim 1, wherein matching applies a RANSAC (RANdom SAmple Consensus) order to the several matches.

14. The method of claim 1, wherein computing comprises:
determining a translation between a center of mass of the first set and a center of mass of the second set; and
determining an angular momentum between the first set and the second set.

15. The method of claim 1, further comprising:
matching, for several second-hand matches, a plurality of the first plurality of touch detections to a corresponding plurality of the second plurality of touch detections, wherein the plurality of the first plurality of touch detections and the corresponding plurality of the second plurality of touch detections comprise a third set and a fourth set, and matching, for each second-hand match, further comprises:
computing a rotation and translation matrix between the third set and the fourth set;
applying the rotation and translation matrix to the third set to determine a result; and
calculating a Euclidian distance between the result and the fourth set; and
selecting a second-hand match, from the several second-hand matches, having a minimum Euclidian distance.

16. A device for touch detection, the device comprising:
a touch sensor configured to:
receive first touch data comprising a first plurality of touch detections recorded at a first time; and
receive second touch data comprising a second plurality of touch detections recorded at a second time; and
a processor coupled to the touch sensor and configured to:
match, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the processor, for each match, is further configured to:
compute a rotation and translation matrix between the first set and the second set;
apply the rotation and translation matrix to the first set to determine a result; and
calculate a Euclidian distance between the result and the second set; and
select a match, from the several matches, having a minimum Euclidian distance.

17. The device of claim 16, wherein the rotation and translation matrix comprises a single matrix.

18. The device of claim 16, wherein the processor configured to apply the rotation and translation matrix is configured to multiply each point in the first set with the rotation and translation matrix to form the result.

19. The device of claim 16, wherein the processor configured to select the match is configured to select a first match having a Euclidian distance less than a threshold distance.

20. The device of claim 16, wherein the processor configured to match is configured to apply an exhaustive matching.

21. The device of claim 16, wherein the processor configured to compute is configured to:
determine a translation between a center of mass of the first set and a center of mass of the second set; and
determine an angular momentum between the first set and the second set.

22. A device for touch detection, the device comprising:
means for receiving first touch data comprising a first plurality of touch detections recorded at a first time;
means for receiving second touch data comprising a second plurality of touch detections recorded at a second time;
means for matching, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the means for matching, for each match, further comprises:
means for computing a rotation and translation matrix between the first set and the second set;
means for applying the rotation and translation matrix to the first set to determine a result; and
means for calculating a Euclidian distance between the result and the second set; and
means for selecting a match, from the several matches, having a minimum Euclidian distance.

23. The device of claim 22, wherein the rotation and translation matrix comprises a single matrix.

24. The device of claim 22, wherein the means for applying the rotation and translation matrix comprises means for multiplying each point in the first set with the rotation and translation matrix to form the result.

25. The device of claim 22, wherein the match selected has a Euclidian distance less than a threshold distance.

26. The device of claim 22, wherein the means for matching comprises means for applying an exhaustive matching.

27. The device of claim 22, wherein the means for computing comprises:
means for determining a translation between a center of mass of the first set and a center of mass of the second set; and
means for determining an angular momentum between the first set and the second set.

28. A non-transient computer-readable storage medium including program code stored thereon, comprising program code to:
receive first touch data comprising a first plurality of touch detections recorded at a first time;
receive second touch data comprising a second plurality of touch detections recorded at a second time;
match, for several matches, a plurality of the first plurality of touch detections to a corresponding plurality of the second plurality of touch detections, wherein the plurality of the first plurality of touch detections and the corresponding plurality of the second plurality of touch detections comprise a first set and a second set, and the program code to match, for each match, further comprises program code to:
compute a rotation and translation matrix between the first set and the second set;
apply the rotation and translation matrix to the first set to determine a result; and
calculate a Euclidian distance between the result and the second set; and
select a match, from the several matches, having a minimum Euclidian distance.

29. The non-transient computer-readable storage medium of claim 28, wherein movement is above a threshold speed.
